(19) United States
(12) Patent Application Publication
(10) Pub. No.: US 2007/0278116 A1
(43) Pub. Date: Dec. 6, 2007

(54) Method Of Producing A Tubular Pouch Having A Standing Base Formed Integrally Therewith, And Tubular Pouch

(76) Inventor: Andreas Michalsky, Memmingen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/593,440

(22) PCT Filed: Feb. 24, 2005
(86) PCT No.: PCT/EP05/01962

§ 371 Date: Jun. 19, 2007

(30) Foreign Application Priority Data
Mar. 16, 2004 (DE) 10 2004 012814.6

(51) Int. Cl. B65D 35/00; B29C 57/10

(52) U.S. Cl. 206/277; 493/308

(57) ABSTRACT

The invention relates to a method of producing a tubular pouch (10) having a standing base (20) formed integrally therewith, the standing base (20) being formed by sealing an end (30) of a tubular portion (40) that forms the tubular pouch (10) and drawing the sealed tubular pouch end (30) into the tubular pouch portion (40). The invention further relates to a tubular pouch produced by that method.

The invention relates to a method of producing a tubular pouch having a standing base formed integrally therewith, in accordance with the preamble of patent claim 1, and also to a tubular pouch having such a standing base, in accordance with the preamble of patent claim 6.

Tubular pouches have been in use for quite some time now for packaging commodities, or filling materials, that are liquid, solid or in paste form such as, for example, foodstuffs and drinks and, because of their low weight and the small volume that they occupy when empty, their use is popular. In addition, tubular pouches are usually economical to manufacture and can be disposed of in relatively problem-free manner.

However, it has been found to be problematic that tubular pouches generally have little stability when standing and accordingly special measures have to be taken in order to prevent tubular pouches, especially opened tubular pouches, from toppling over and, as a result thereof, spilling their contents. This problematic situation is a result of the fact that hitherto known tubular pouches have inadequate standing stability. In the past, it has therefore been attempted to improve the inadequate standing stability of the above-mentioned tubular pouches by integrating into the tubular pouch a base having standing stability by means of the fact that a separate base is sealed to, or into, that tubular part of the tubular pouch which forms the tubular pouch or is connected thereto by some other means.

In the case of that procedure, however, two disadvantages became apparent, which manifested themselves firstly in a problem of sealing between the sealed-in base and the tubular part to which it is sealed and secondly in inadequate foldability and accordingly in a relatively large volume being occupied by the tubular pouch when empty, as a result of which the volume taken up by the empty tubular pouch when being disposed of was in turn increased.

A further procedure used hitherto for improving the standing stability of a tubular pouch consisted of providing a standing base in the form of a W-shaped fold, which was made from an integral film blank in order to avoid inadequate sealing. Even though this had substantially improved sealing compared to tubular pouches having a sealed-in base, the provision of the W-shaped fold resulted in the standing base's always being at least somewhat distorted into an oval shape so that again the standing stability of that tubular pouch was inadequate.

The problem underlying the invention is to make available a tubular pouch having a standing base formed integrally therewith which, besides being economical to manufacture, has a high sealing capability and, in addition, standing stability, whilst avoiding the above-mentioned disadvantages of the prior art.

The problem is solved by a method according to patent claim 1 and by a tubular pouch according to patent claim 6.

More specifically, the problem is solved by a method of producing a tubular pouch having a standing base formed integrally therewith, wherein the standing base is formed by sealing an end of a tubular portion that forms the tubular pouch and drawing the sealed tubular pouch end into the tubular portion.

An important aspect of the invention lies in the fact that, firstly, the use of heterogeneous materials and materials having disparate material thicknesses such as, for example, a separate stand base is dispensed with and, in addition, the length of the sealed seam is made as short as possible.

By avoiding heterogeneous materials and/or materials of different thicknesses, that is to say by using just a single film blank, it is possible to reduce the number of parameters to be considered during sealing, especially with regard to the thickness of the material and nature of the material, and as a result to simplify substantially the sealing method compared to methods used hitherto for the sealing-in of bases. In addition, by producing a sealed seam that is as short as possible and that is advantageously formed of only two layers, namely by simple inside-to-inside sealing of the two inside surfaces of a pressed-together tubular portion, it is possible to reduce the risk of inadequate sealing so that this becomes almost zero.

It is furthermore possible, by means of this simple two-layer sealing in accordance with the invention, to dispense with complicated transitions, such as are necessary, for example, in the case of production of a W-shaped fold, where there is a transition from a four-layered sealing layer to a two-layered one. In the location of transition from four to two layers a sealed seam has an inherent risk of rupture or peeling so that inadequate sealing has to be expected.

A further advantage of the procedure according to the invention lies in the fact that, as a result of drawing the sealed tubular pouch end into the tubular pouch portion, a pocket which is completely sealed to the bottom is formed so that it is reliably ensured that no filling material can escape from the tubular pouch.

In accordance with the invention, when the sealed tubular pouch end is drawn into the tubular pouch portion or tubular pouch body, a folded-over border is produced, which forms, or which comprises, a standing surface.

Furthermore, in accordance with an advantageous embodiment, a portion drawn into the tubular pouch body is held in the tubular pouch body at least pointwise, especially at a plurality of, advantageously at least three, points, and is especially sealed together with or to the tubular pouch body. As a result, it is ensured that, when the tubular pouch is being filled, the sealed tubular pouch end drawn into the tubular pouch body is pushed back out from the tubular pouch body.

In accordance with the invention, the sealing between the drawn-in portion and the tubular pouch body is an inside-to-inside seal, which is of point, dash or line formation and which causes the portion drawn into the tubular pouch body to be reliably fixed in the tubular pouch body. Preferably, those holding seals are arranged along a substantially horizontal line spaced a constant distance away from the standing surface. The line spacing corresponds approximately to the maximum distance that the sealed tubular pouch end is drawn in at the border.

In order to improve the standing stability, the folded-over border is furthermore likewise provided with a seal arranged in its bottom end region or, where appropriate, spaced a small distance away therefrom. This seal, which is preferably in the form of an inside-to-inside seal, results on the one hand in a stiffening of the folded-over border, which already in itself brings about an improvement in the standing stability. In addition, it is possible for the folded-over border to be sealed with a prespecified peripheral shape, which can be prespecified by a sealing tool. For example by using a circular sealing tool applied to both sides of the folded-over border in an annular arrangement, this shape can be formed so that it is round. It is furthermore possible to provide the folded-over border with corners so that, for example, a tubular pouch having a square or triangular standing surface is obtained.

A further advantage of the procedure according to the invention lies in the fact that, as a result of drawing the sealed tubular pouch end into the tubular pouch body, a two-layer, that is to say a strengthened, folded-over border is formed. The folded-over border in the standing surface region is accordingly at least twice as thick as the tubular pouch body, which accommodates the filling material itself, so that a high degree of standing stability is always ensured inter alia by means of the relatively substantially formed folded-over border and also as a result of a lowering of the centre of gravity which accompanies it.

In accordance with a procedure according to the invention, the sealed tubular pouch end is turned back in on itself into the tubular pouch body around a sleeve. Using a sleeve having an even end portion, which is preferably round in shape, ensures that the sealed tubular pouch end is drawn uniformly into the tubular pouch body and the resulting standing surface is formed without folds or unevenness, which again optimises the standing stability of the tubular pouch according to the invention.

As mentioned hereinbefore, the problem according to the invention is furthermore solved by a tubular pouch having a standing base formed integrally therewith, the standing base being formed by sealing an end of a tubular portion that forms the tubular pouch and drawing the sealed tubular pouch end into the tubular portion, and a standing surface being formed by a folded-over border formed in the course of drawing-in.

In accordance with the invention, a portion drawn into the tubular portion or tubular pouch body, is held at least pointwise in the tubular pouch body especially along a notional, substantially horizontally extending line. In accordance with a preferred embodiment, the drawn-in portion in that case is connected to the tubular pouch body by means of an inside-to-inside seal.

Furthermore, the folded-over border is sealed in its standing surface region, which strengthens the two-layer folded-over border formed by the folding-over or the turning back in. In addition to increased standing stability, this measure advantageously provides at the same time a further fluid barrier in the standing base region which prevents filling material escaping from the tubular pouch. This is advantageous especially in the case of a rough or possibly sharp-edged underlying surface, which could damage, or, for example, pierce, the standing surface.

In accordance with the invention, the tube is either produced with a lap seal or is extruded in tube form. In addition, the tube is so provided that it can be sealed inside-to-inside by thermal means or with the aid of ultrasound and has at least one barrier layer. The barrier layer can, depending on the area of use, be of EVOH, SiO₂ or provided in the form of an aluminium layer or foil. In accordance with the invention, that barrier layer is covered over, at least on the inside of the tube, by a sealable layer.

Further embodiments of the invention are to be found in the subordinate claims.

The invention will be described hereinbelow with reference to an exemplary embodiment explained in greater detail with reference to the drawings, in which:

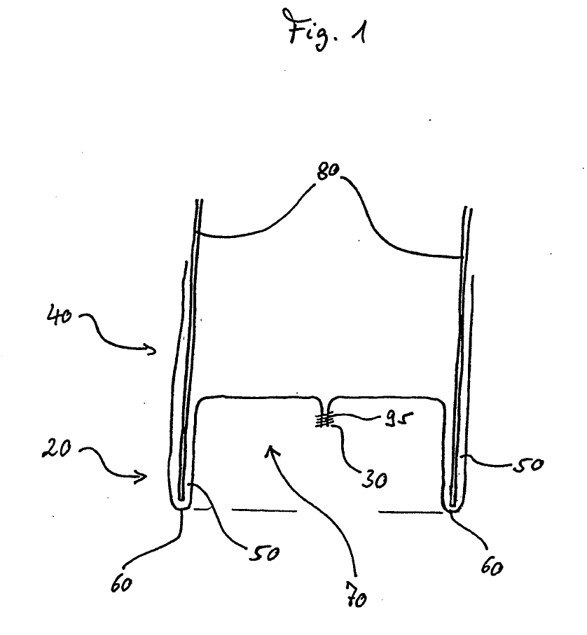

FIG. 1 shows, in diagrammatic form, production of a tubular pouch according to the invention, having a standing base formed integrally therewith, in a sectional view;

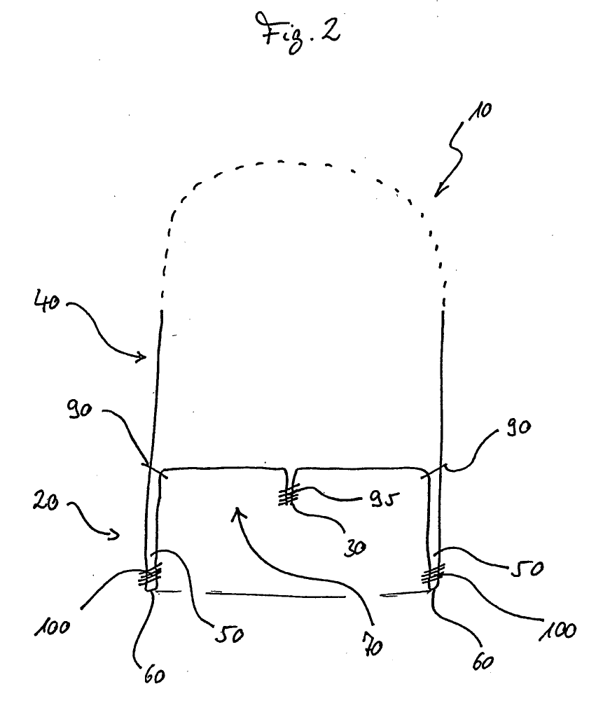

FIG. 2 shows, in diagrammatic form, a tubular pouch according to the invention, having a sealed standing base, in a sectional view.

In the description that follows, the same reference numerals are used for parts that are the same or that act in the same way.

FIG. 1 shows, in diagrammatic form, a method of producing a tubular pouch 10 having a standing base 20 formed integrally therewith, the standing base 20 being formed by sealing an end 30 of a tubular portion 40 that forms the tubular pouch and drawing the sealed tubular pouch end 30 into the tubular pouch portion 40. The sealed tubular pouch end 30 is turned back in on itself into the tubular pouch body 40 around a sleeve 80 and forms a drawn-in portion 70. As a result of drawing in the sealed tubular pouch end 30, which is provided with a tubular pouch end seal 95, a two-layer folded-over border 50 is formed, at the bottom end of which is arranged a standing surface 60. As a result of this procedure according to the invention, the tubular pouch 10 is provided by simple means with a standing base 20 which ensures that the tubular pouch can stand securely.

FIG. 2 shows, in diagrammatic form, a tubular pouch 10 according to the invention in accordance with FIG. 1, wherein the drawn-in portion 70 has been fixed by means of seals 90. Furthermore, in the bottom region of the folded-over border 50, a fold-over seal 100 is provided. The seals are shown, in diagrammatic form, by oblique lines.

At this point it should be stated that all above-described parts, considered on their own and in any combination, especially the details shown in the drawings, are claimed as being important for the invention. The skilled person will be familiar with modifications thereof.

### LIST OF REFERENCE NUMERALS

10 tubular pouch
20 standing base
30 tubular pouch end
40 tubular portion/tubular pouch body
50 folded-over border
60 standing surface
70 drawn-in portion
80 sleeve
90 seal in point form
95 tubular pouch end seal
100 fold-over seal

1. Method of producing a tubular pouch having a standing base formed integrally therewith, the method comprising the steps of:
forming the standing base by sealing an end of a tubular portion that forms the tubular pouch, and
drawing the sealed tubular pouch end into said tubular portion.

2. Method according to claim 1, further including the step of forming, when the sealed tubular pouch end is drawn into the tubular portion or tubular pouch body, a folded-over border which forms a standing surface.

3. Method according to claim 1, wherein a portion drawn into the tubular pouch body is held in the tubular pouch body.

4. Method according to claim 3, further including the step of sealing the said portion drawn into the tubular pouch body to the tubular pouch body, at least pointwise.

5. Method according to claim 2, wherein said folded-over border is sealed.

6. Method according claim 1, further including the step of turning said sealed tubular pouch end back in on itself into the tubular pouch body around a sleeve.

7. A tubular pouch comprising:
a tubular portion defining said pouch, and a standing base formed integrally therewith, said standing base being formed by sealing an end of said tubular portion and drawing the sealed tubular pouch end into the tubular portion, and a standing surface being formed by a folded-over border formed in the course of drawing-in.

8. A tubular pouch according to claim 7, wherein a portion drawn into the tubular pouch body is held in the tubular pouch body.

9. A tubular pouch according to claim 8, wherein said portion drawn into said tubular pouch body is sealed to the tubular pouch body, at least pointwise.

10. A tubular pouch according to claim 7, wherein said folded-over border is sealed.

11. A tubular pouch according to claim 7, wherein the tube of the tubular pouch is formed by a tube selected from the group consisting a tube with a lap seal, and a tube extruded in tube form.

12. A tubular pouch according to claim 7, wherein said tube is arranged to be sealed inside-to-inside.

13. A tubular pouch according to claim 7, wherein said tube has at least one barrier layer.
